(19) United States
(12) Patent Application Publication
(10) Pub. No.: US 2021/0289905 A1
(43) Pub. Date: Sep. 23, 2021

(54) SMARTPHONE CASE EQUIPPED WITH POCKET WARMER STORAGE FUNCTION

(71) Applicant: Tsutomu TANAKA, Sapporo (JP)

(72) Inventor: Tsutomu TANAKA, Sapporo (JP)

(21) Appl. No.: 17/206,666

(22) Filed: Mar. 19, 2021

(30) Foreign Application Priority Data
Mar. 19, 2020 (JP) 2020-049248

(51) Int. Cl. A45C 15/00; H04B 1/3827; A45C 11/00; A45C 13/02

(52) U.S. Cl. CPC A45C 15/00; H04B 1/3827; A45C 2011/002; A45C 13/02; A45C 11/00

(57) ABSTRACT

A smartphone case equipped with a pocket warmer storage function that can be used while warming up the smartphone with a disposable pocket warmer, and can promote heat generation due to oxidation by rubbing when the temperature drops. A smartphone case 1 equipped with a pocket warmer storage function that can store a disposable pocket warmer 10 and can use to warming up the smartphone equipped with the pocket warmer 10, is disposed on the back side of the smartphone body 100 and has the flexibility capable of rubbing the stored disposable pocket warmer 10 from the outside, and has a pocket warmer storage body 3 having a heat retaining property of retaining the heat generated from the disposable pocket warmer 10 inside.

### TECHNICAL FIELD

The present disclosure relates to a smartphone case equipped with a pocket warmer storage function that can be used while warming up a smartphone by a disposable pocket warmer.

### BACKGROUND ART

In recent years, more and more people are climbing winter mountains with a sense of sports, such as backcountry skiing and backcountry snowboarding. Meanwhile, in winter mountains, due to heavy snowfall or snowstorm, the field of view is deprived and the sense of direction is lost, thereby being in danger of meeting with a disaster

Smartphones are provided with a map function and a compass function using GPS, and can search for their own position and the direction they are directing. For this reason, climbers, skiers, and snowboarders who climb winter mountains often carry smartphones instead of a paper map or a compass using magnetic needles.

On the other hand, smartphones have problems that when exposed to a low temperature, the battery performance is deteriorated and the protective function is operated and thus unusable, Especially, in recent smartphones, the amount of heat generated by the CPU is increased together with the high precision of the information processing capability, and the structure is weak to low temperatures because metal such as aluminum is used for the body so that heat can be easily dissipated. Therefore, people are overconfident by carrying a smartphone in the winter mountains. When they want to use the smartphone in the event of a distress, it does not work and so they cannot use the GPS function, thereby leading to accidents that result in loss of life.

By the way, iron generates an oxidizing heat when it is oxidized. A disposable pocket warmer is a heating device that utilizes the oxidizing heat generated when this iron is oxidized. When it is taken out of a sealed film container, it generates heat by chemically reacting with oxygen in the air. This disposable pocket warmer is widely used as a heater because it is highly portable and inexpensive.

Therefore, so far, it has been proposed to use a disposable pocket warmer as a method for warming a smartphone in a low temperature environment. For example, a method has been proposed in which a disposable pocket warmer having an adhesive capable of attaching itself to clothing or the like is attached directly to a smartphone.

Further, in Japanese Unexamined Patent Application Publication No. (Hei) 6-53668 suggests an invention relating to a protective case for mobile terminals provided with a heating element storage unit for storing pocket warmers at the bottom of the main body case for storing mobile terminals (Patent Literature 1).

### PRIOR ART REFERENCE

### Patent Literature

Patent Literature 1: Japanese Unexamined Patent Application Publication No. (Hei) 6-53668

### SUMMARY OF THE INVENTION

### Technical Problem

However, when using a map function of a smartphone, it must be taken out from a pocket or the like for use. Therefore, a disposable pocket warmer attached to a smartphone has a problem that the heat generated by exposure to outside air is released, and thus the smartphone is not sufficiently warmed up.

In addition, the disposable pocket warmer need to be rubbed to promote a chemical reaction with oxygen in the air. However, in the invention described in Patent Literature 1, since the disposable pocket warmer is covered with the heating element storage unit, it is not possible to rub it.

The present disclosure has been made to solve the above-mentioned problems, and an object of the present disclosure is to provide a smartphone case equipped with a pocket warmer storage function, which can be used while keeping the smartphone warm with a disposable pocket warmer, and can promote heat generation due to oxidation by rubbing when the temperature drops.

### Technical Solution

The smartphone case equipped with a pocket warmer storage function according to the present disclosure is a smartphone case equipped with a pocket warmer storage function that can store a disposable pocket warmer and warm up the smartphone with the pocket warmer, in an attempt to suppress heat dissipation at the time of warming and using the smartphone and to rub the disposable pocket warmer to promote its chemical reaction when the temperature drops, wherein the smartphone case includes a pocket warmer storage body which is disposed on the back. side of the smartphone body, has the flexibility that allows the stored disposable pocket warmer to be rubbed from the outside, and further has a heat retention property capable of retaining heat generated from the disposable pocket warmer inside.

Also, as one aspect of the present disclosure, in order to solve the problem of enhancing the adhesion between the disposable pocket warmer and the smartphone and improving the function of warming up the smartphone, the pocket warmer storage body may be made of a material that presses the stored disposable pocket warmer to the back side of the smartphone body and closely adheres thereto.

Further, as one aspect of the present disclosure, in order to solve the problem of enhancing the adhesion between the disposable pocket warmer and the smartphone and improving the function of warming up the smartphone, the pocket warmer storage body is formed of a sheet material having elasticity, and at the same time, is formed so that a dimension in the thickness direction of the storage space for storing the disposable pocket warmer is thinner than the thickness dimension of the disposable pocket warmer.

Further, as one aspect of the present disclosure, in order to solve the problem of enhancing the adhesion between the disposable pocket warmer and the smartphone and improving the function of warming up the smartphone, the pocket warmer storage body is formed of a bag-shaped cloth containing a filler having a swelling property, and at the same time, is formed so that a thickness direction of the storage space for storing the disposable pocket warmer is thinner than the thickness dimension of the disposable pocket warmer in a state where the filler is swollen.

Further, as one aspect of the present disclosure, in order to solve the problem that a configuration is provided in which the pocket warmer storage body is disposed on the back side of the smartphone body, the aspect includes a case body having a shape that can be attached to and detached from the back side of the smartphone body, and having a pocket warmer entrance/exit opened to a size that allows the disposable pocket warmer to be taken in and out, wherein the pocket warmer storage body may be provided on the back side of the case body so as to cover the pocket warmer entrance/exit.

Further, as one aspect of the present disclosure, in order to solve the problem that the area for warming up the smartphone is increased by allowing the disposable pocket warmer to be disposed in every corner of the pocket warmer storage body, the pocket warmer storage body may have a folded-back fixing part that is fixed to the outer surface of the pocket warmer entrance/exit peripheral edge part in a state where the outer peripheral edge part is folded back in the direction of the case body.

Further, as one aspect of the present disclosure, in order to solve the problem that a folded-back fixed portion is easily formed and the dimension in the thickness direction of the accommodation space for storing the disposable pocket warmer is easily set, the pocket warmer storage body has a fixing ring member formed in an annular shape to be fixed along the peripheral edge of the pocket warmer entrance/exit, and is formed by folding back the outer peripheral edge part of the fixing annular member and the outer peripheral edge part of the pocket warmer storage body are folded in the inward direction facing each other and the respective tip edge parts are sutured together.

Further, as one aspect of the present disclosure, in order to solve the problem that a configuration is provided in which the pocket warmer storage body is disposed on the back side of the smartphone body, the aspect may include a frame body which is formed in a rectangular frame shape so as to have an operation opening for operating the display of the smartphone body, and is disposed corresponding to the outer peripheral edge part on the front side of the smartphone body, and include a smartphone entrance/exit section that is attached to each frame part of the frame body so that the disposable pocket warmer can be stored on the back surface of the smartphone body, and is detachably configured between any of the frame parts to allow the smartphone body to be taken in and out.

### Advantageous Effects

According to the present disclosure, the smartphone can be used while being kept warm by the disposable pocket warmer, and when the temperature drops, heat generation can be promoted due to oxidation by rubbing the pocket warmer.

### BRIEF DESCRIPTION OF THE DRAWING

FIG. 1 is a front perspective view showing a first embodiment of a smartphone case equipped with a pocket warmer storage function according to the present disclosure.

FIG. 2 is a rear side perspective view showing a smartphone case equipped with a pocket warmer storage function according to the first embodiment.

FIG. 3 is a cross-sectional view showing a state in which a disposable pocket warmer is stored and a smartphone body is attached in the first embodiment.

FIG. 4 is a cross-sectional view showing another embodiment of the folded-back fixing part.

FIG. 5 is a cross-sectional view showing another embodiment of the pocket warmer storage body.

FIG. 6 is a schematic view showing another embodiment of a material having both flexibility and elasticity used in a pocket warmer storage body.

FIG. 7 is a front side perspective view showing a second embodiment of a smartphone case equipped with a pocket warmer storage function according to the present disclosure.

FIG. 8 is a cross-sectional view showing a smartphone case equipped with a pocket warmer storage function according to the second embodiment.

FIGS. 9A to 9E are schematic views showing a method of storing a disposable pocket warmer and mounting a smartphone body in the second embodiment.

### DETAILED DESCRIPTION OF THE EMBODIMENTS

Hereinafter, the first embodiment of the smartphone case equipped with a pocket warmer storage function according to the present disclosure will be described with reference to the accompanying drawings.

A smartphone case 1 equipped with a pocket warmer storage function according to the first embodiment is a smartphone case that stores a disposable pocket warmer 10 and can be used to warm up a smartphone by the disposable pocket warmer 10, and that includes a case body 2 provided equipped with a pocket warmer entrance/exit 21 and a pocket warmer storage body 3 for covering the back side of the pocket warmer entrance/exit 21. Hereinafter, each configuration will be described in detail.

The case body 2 is a case that can be attached to/detached from the smartphone body 100, and is fanned in a shape attachable to/detachable from the back side of the smartphone body 100. The back side of the smartphone body 100 is the rear side when a side on which the touch-operable display is disposed is a front side.

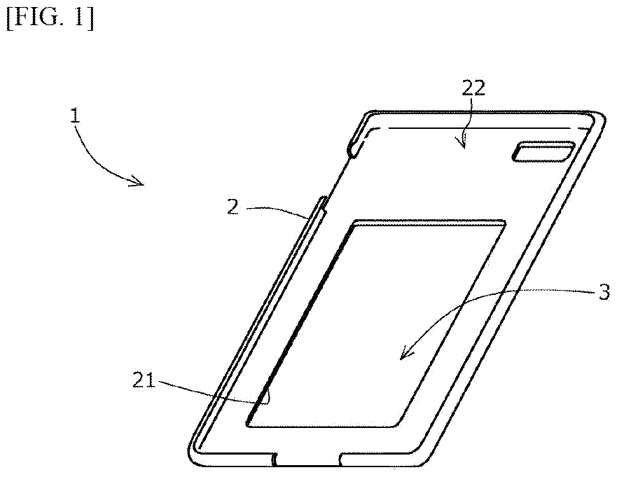

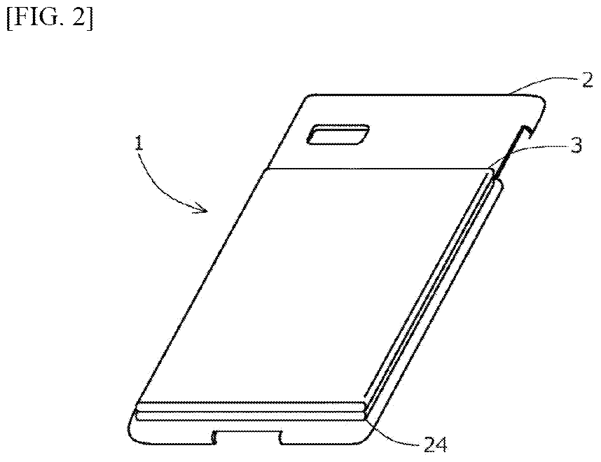

As shown in FIGS. 1 and 2, the case body 2 in the first embodiment is formed in a vertically long-nearly rectangular parallelepiped shape, and is formed with a fitting groove 22 formed in a concave shape to fit the shape of the smartphone body 100. In addition, the case body 2 is suitably formed with a notch that enables operation of various buttons such as a power button and a switch that switches functions in a state in which the smartphone body 100 is attached, a hole disposed in the camera lens unit for enabling camera photography, a notch through which a charging cable is inserted, and the like.

The pocket warmer entrance/exit 21 is an opening for entering and exiting the disposable pocket warmer 10 from the bottom of the fitting groove 22 into a pocket warmer storage body 3 installed on the back side of the case body 2, and also is an opening for bringing the disposable pocket warmer 10 stored in the pocket warmer storage body 3 into close contact with the back side of the smartphone body 100. Therefore, the pocket warmer entrance/exit 21 has a size that. allows the disposable pocket warmer 10 to be taken in and out, and is opened to a size that widens the area where the disposable pocket warmer 10 is directly brought into close contact with the smartphone body 100. Since the dimension of the disposable pocket warmer 10, which is generally formed in a substantially rectangular shape, is formed to be about 50 mm to 200 mm per side, the pocket warmer entrance/exit 21 is preferably opened to have the similar dimension.

The pocket warmer storage body 3 is for storing the disposable pocket warmer 10 on the back side of the smartphone body 100, and in the first embodiment, it is provided on the back side of the case body 2 so as to cover the pocket warmer entrance/exit 21. The pocket warmer storage body 3 has the flexibility capable of rubbing the stored disposable pocket warmer 10 from the outside in a state where the smartphone body 100 is attached, and also has a heat retention property capable of retaining heat generated from the disposable pocket warmer 10 inside.

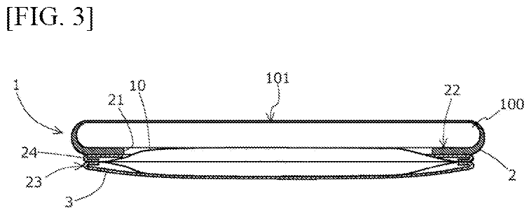

Further, as shown in FIG. 3, in order to bring the disposable pocket warmer 10 into contact over a wide range up to the position close to the end part of the smartphone body 100, the pocket warmer storage body 3 has a folded-back fixing part 23 that is fixed to the outer surface of the peripheral edge of the pocket warmer entrance/exit 21 in a state where the outer peripheral edge part is folded back in the direction of the case body 2. In the first embodiment, in order to facilitate the formation of the folded-back fixing part 23 and to easily set the dimension in the thickness direction of the storage space for storing the disposable pocket warmer 10, it has a fixing annular member 24 fanned in an annular shape to be fixed along the peripheral edge part of the pocket warmer entrance/exit 21. And, the outer peripheral edge part of the fixing annular member 24 and the outer peripheral edge part of the pocket warmer storage body 3 are folded back in the inward direction of facing each other and the respective tip edge parts are sutured, thereby forming the folded-back fixing part 23.

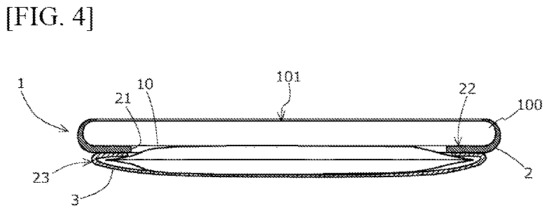

The formation of the folded-back fixing part 23 is not limited to the configuration having the fixing annular member 24, but as shown in FIG. 4, the outer peripheral edge part of the pocket warmer storage body 3 may be configured so as to be fixed to the outer peripheral surface of the peripheral edge part of the pocket warmer entrance/exit 21.

Further, the pocket warmer storage body 3 is preferably made of a material that could press the stored disposable pocket warmer 10 to the back side of the smartphone body 100 and could closely adhere thereto. Therefore, the pocket warmer storage body 3 in the first embodiment is formed of a sheet material having elasticity, and also is formed so that the dimension in the thickness direction of the storage space for storing the disposable pocket warmer 10 is smaller than the thickness dimension of the disposable pocket warmer 10. Thereby, the pocket warmer storage body 3 is configured so that the stored disposable pocket warmer 10 is pressed to the back side of the smartphone body 100 via the pocket warmer entrance/exit 21 and closely adheres thereto.

Examples of a material with elasticity along with flexibility and heat retaining property lo used for the pocket warmer storage body 3 may include fabrics such as foamed chloroprene used for dry suits and wet suits, and fabrics in which chemical fibers such as acrylic, rayon, nylon, and polyurethane are knitted so as to have elasticity.

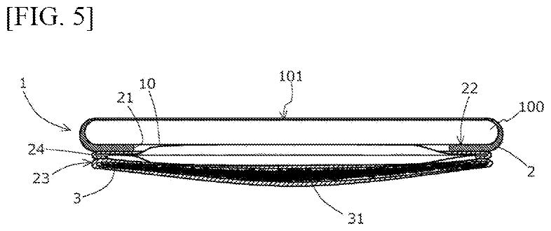

Further, as another material, as shown in FIG. 5, a bag-shaped fabric containing a filler 31 having a swelling property can be used. Examples of fillers 31 include feathers such as down and feathers, stuffed cotton made of cotton, etc. and sponge made of formed synthetic resin such as polyurethane, etc., in order to increase heat retention while providing flexibility. That is, as the pocket warmer storage body 3, a fabric formed so that the dimension in the thickness direction of the storage space for storing the disposable pocket warmer 10 in the swollen state of the filler 31 is thinner than the thickness dimension of the disposable pocket warmer 10 is used, so that the stored disposable pocket warmer 10 can be pressed to the back side of the smartphone body 100 via the pocket warmer entrance/exit 21 and closely adheres thereto.

The pocket warmer storage body 3 is not limited to one made of one material. For example, it may be configured by overlapping a material having flexibility and a material having high heat retention performance.

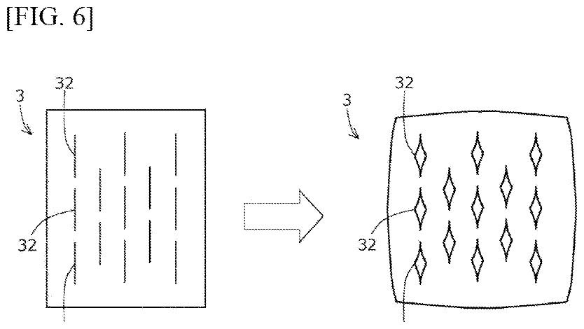

Further, in order to provide flexibility and elasticity, a plurality of notches 32 may be provided in the material as shown in FIG. 6, and although not shown, pleats may be applied. As a result, materials having low flexibility and elasticity such as animal leather and synthetic leather can also be used as the material of the pocket warmer storage body 3.

According to the first embodiment as described above, the following functions and effects can be obtained.

1. The smartphone body 100 can be warmed up by the disposable pocket warmer 10 stored in the pocket warmer storage body 3.

2. Since the heat generated from the disposable pocket warmer 10 can be retained inside by providing a heat retaining property to the pocket warmer 3, the smartphone body 100 can be kept warm even if it is taken out of a pocket or the like and exposed to the outside air.

3. By providing a flexibility to the pocket warmer 3, the disposable pocket warmer 10 can be rubbed in the state of being stored, and when the temperature drops, it can be rubbed into contact with air to promote heat generation due to oxidation.

4. Since the disposable pocket warmer 10 stored in the pocket warmer storage body 3 is pressed to the back side of the smartphone body 100 and is closely adhered thereto, the heat of the disposable pocket warmer 10 can be directly transferred to the smartphone body 100.

5. By forming the folded-back fixing part 23 on the outer peripheral edge of the pocket warmer storage body 3, the disposable pocket warmer 10 can be disposed in every corner, and a large area on the back side of the smartphone body 100 can be warmed up.

6. By providing the fixing annular member 24, the folded-back fixing part 23 can be easily formed and it is possible to easily form the folded-back fixing part 23 and to easily set the dimensions in the thickness direction of the storage space that stores the disposable pocket warmer 10.

Next, the second embodiment of the present disclosure will be described. The same or equivalent configurations as those described in the first embodiment described above are designated by the same reference numerals, and additional description thereof will be omitted.

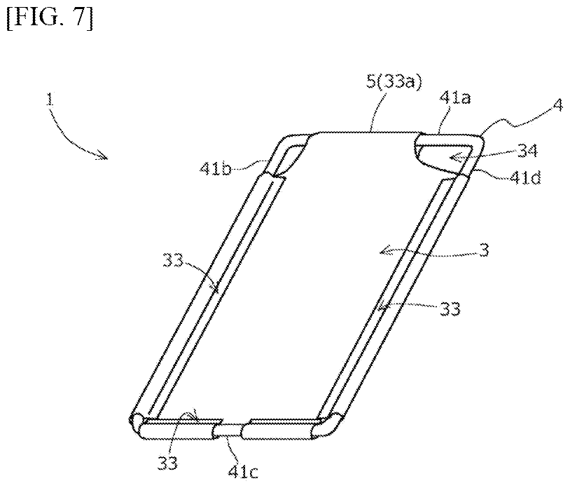

The smartphone case 1 equipped with a pocket warmer storage function of the second embodiment includes a frame body 4 disposed corresponding to the outer peripheral edge part on the front side of the smartphone body 100, and a pocket warmer storage body 3 attached to each frame part 41 of this frame body 4, as shown in FIG. 7.

The frame body 4 becomes a part of a case for storing the smartphone body 100 by attaching the pocket warmer storage body 3, and the frame body 4 is formed in a rectangular frame shape so as to have an operation opening 42 capable of operating the display 101 of the smartphone body 100. In the second embodiment, the frame body 4 is formed by bending a round bar-shaped bar into a vertically long-rectangle shape according to the shape of the smartphone body 100. And, as shown in FIG. 7, each frame part 41 corresponding to the four sides forming the rectangle is disposed corresponding to the outer peripheral edge on the front side of the smartphone body 100, whereby the smartphone body 100 is locked so to be not come out of the operation opening 42.

Moreover, the cross-sectional shape of the frame body 4 is not limited to a round shape, and may be appropriately selected from shapes that can engagingly lock the smartphone body 100, such as a rectangular shape and an L-shape. Further, the manufacturing method of the frame body 4 is not limited to the one manufactured by bending the bar material. For example, it may be appropriately selected from forging, casting, cutting, welding, bonding, etc., and may be manufactured by a 3D printer or the like. Further, the material of the frame body 4 may be appropriately selected from a metal such as stainless steel and aluminum, a synthetic resin such as plastic, and the like.

In the second embodiment, the pocket warmer storage body 3 is attached to each frame part 41 of the frame body 4 so that the disposable pocket warmer 10 can be stored on the back surface of the smartphone body 100. Further, the pocket warmer storage body 3 is configured to be detachably attached between any of the attached frame parts 41, and the pocket warmer storage body 3 constitutes a smartphone entrance/exit section 5 that allows the smartphone body 100 to be taken in and out.

In the second embodiment, with respect to the flame parts 41b and 41d corresponding to the left and right long side parts of each frame part 41 formed in a vertically long-rectangular shape and the frame parts 41c corresponding to the lower short side part, it is attached by adhering or suturing the edge part 33 of the pocket warmer storage body 3 folded back from the outside of the frame 41. The pocket warmer storage body 3 attached to the lower frame part 41c is formed with an insertion part 33 formed in a notch shape for inserting the charging cord into the smartphone to main body 100.

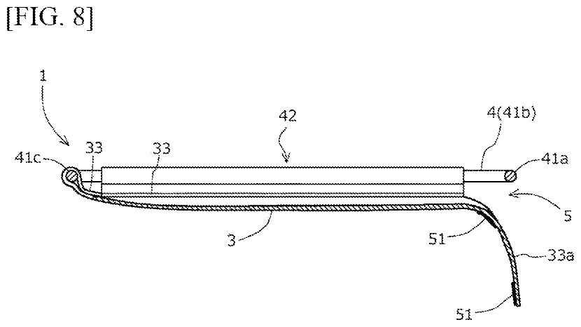

Further, the smartphone entrance/exit section 5 is configured on the upper short side portion of the frame body 4. Specifically, as shown in FIG. 8, the upper edge part 33a of the pocket warmer storage body 3 is formed to he sufficiently longer than the time body 4, and passes through the inside of the upper frame part 41a and can be folded back to the outside. A hook-and-loop fastener 51 is provided at a position where the upper edge 33a of the pocket warmer storage body 3 is folded and overlapped, and can be attached to and detached from the upper frame part 41a. In the second embodiment, a camera hole part 34 in which the camera is disposed is formed. in a portion of the smartphone entrance exit section 5 that is disposed inside the frame body 4.

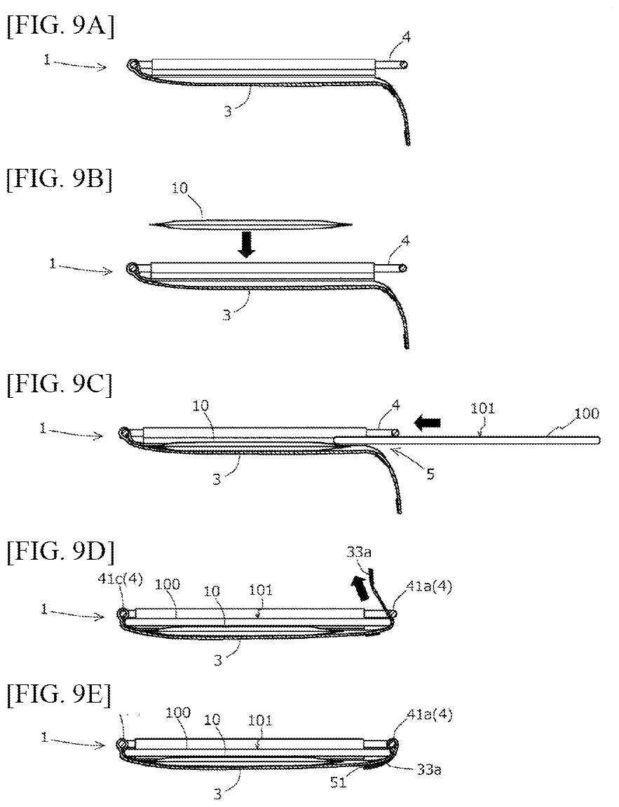

In the second embodiment, as shown in FIGS. 9A-9E, the disposable pocket warmer 10 is stored and the smartphone body 100 is attached. That is, as shown in FIG. 9B, the disposable pocket warmer 10 is stored in the pocket warmer storage body 3, and as shown in FIG. 9C, the smartphone body 100 is inserted from the smartphone entrance/exit section 5. When the outer peripheral edge on the front side of the smartphone body 100 is disposed at the corresponding position of the frame body 4, as shown in FIG. 9D, the upper edge part 33a of the pocket warmer storage body 3 is passed between the upper frame part 41a and the smartphone main body 100. Then, as shown in FIG. 9E, by folding hack the tip and fixing it with the hook-and-loop fastener 51, the disposable pocket warmer 10 and the smartphone body 100 are stored.

According to the second embodiment as described above, the same action and effect as in the first embodiment can be obtained, and the pocket warmer storage body 3 having flexibility can be configured as a part of the case in which the smartphone body 100 is attached. Therefore, since the pocket warmer storage body 3 has flexibility, the switch operation of the smartphone body 100 can be performed without providing a notch or the like. Further, the allowable range for the size and thickness of the smartphone body 100 is wide, and even if the size and thickness of the smartphone body 100 are slightly changed due to, for example, a model change, the smartphone body 100 can continue to be used. Further, according to the second embodiment, although not shown, the disposable pocket warmer 10 can be stored or replaced without completely removing the smartphone body 100 by sliding it slightly.

The smartphone case equipped with a pocket warmer storage function according to the present disclosure is not limited to each of the above-described embodiments, and can be changed as appropriate. For example, although not shown, the case body 2 may be formed in a so-called notebook type having a lid that can be opened and closed.

### DESCRIPTION OF REFERENCE NUMERALS

1: smartphone case equipped with pocket warmer storage function

2: case body

3: pocket warmer storage body

4: frame body

5: smartphone entrance/exit section

10: disposable pocket warmer

100: smartphone body

101: display

21: pocket warmer entrance/exit

22 fitting groove

23: folded and fixed part

24: fixing annular member

31: filler

12: notch

33: edge part

33a: upper edge part

34: camera hole part

41: frame

42: operation opening

51: hook-and-loop fastener

1. A smartphone case equipped with a pocket warmer storage function that can store a disposable pocket warmer and can use the warmer to warm up a smartphone, the smartphone case comprising:
a pocket warmer storage body that is disposed on the back side of the smartphone body, has a flexibility capable of rubbing the stored disposable pocket warmer from the outside, and has a heat retaining property to retain heat generated from the disposable pocket warmer inside.

2. The smartphone case equipped with a pocket warmer storage function according to claim 1, wherein the pocket warmer storage body is made of a material that presses the stored disposable pocket warmer to the back side of the smartphone body and closely adheres the stored disposable pocket warmer thereto.

3. The smartphone case equipped with a pocket warmer storage function according to claim 1, wherein the pocket warmer storage body is formed of a sheet material having elasticity, and is fanned so that the dimension in the thickness direction of the storage space for storing the disposable pocket warmer is thinner than the thickness dimension of the disposable pocket warmer.

4. The smartphone case equipped with a pocket warmer storage function according to claim 1, wherein the pocket warmer storage body is formed of a bag-shaped cloth containing a filler having a swelling property, and is formed so that the thickness direction of the storage space for storing the disposable pocket warmer is thinner than the thickness dimension of the disposable pocket warmer when the filler is inflated.

5. The smartphone case equipped with a pocket warmer storage function according to claim 1, the smartphone case comprising:
a case body having a shape that can be attached to and be detached from the back side of the smartphone body, and having a pocket warmer entrance/exit opened to a size that allows the disposable pocket warmer to be taken in and out,
wherein the pocket warmer storage body is provided on the back side of the case body so as to cover the pocket warmer entrance/exit.

6. The smartphone case equipped with a pocket warmer storage function according to claim 5, wherein the pocket warmer storage body has a folded-back fixing part that is fixed to the outer surface of the peripheral portion of the upper entrance/exit of the pocket warmer in a state where the outer peripheral edge part is folded back in the direction of the case body.

7. The smartphone case equipped with a pocket warmer storage function according to claim 5, wherein the pocket warmer storage body has a fixing annular member formed in an annular shape to be fixed along the peripheral edge of the pocket warmer entrance/exit, and wherein the outer peripheral edge part of the fixing annular member and the outer peripheral edge part of the pocket warmer storage body are folded in the inward direction facing each other and the respective tip edge parts are sutured together.

8. The smartphone case equipped with a pocket warmer storage function according to claim 1, the smartphone case comprising:
a frame body which is formed in a rectangular frame shape so as to have an operation opening for operating a display of the smartphone body, and is disposed corresponding to the outer peripheral edge part on the front side of the smartphone body; and
a smartphone entrance/exit section that is attached to each frame part of the frame body so that the disposable pocket warmer can be stored on the back surface of the smartphone body, and is detachably configured between any of the frame parts to allow the smartphone body to be taken in and out.
